(19) United States
(12) Patent Application Publication
(10) Pub. No.: US 2011/0236786 A1
(43) Pub. Date: Sep. 29, 2011

(54) FUEL CELL

(76) Inventors: Kazutaka Iizuka, Aichi (JP); Chisato Kato, Aichi (JP)

(21) Appl. No.: 12/671,710

(22) PCT Filed: Feb. 12, 2009
(86) PCT No.: PCT/JP2009/052265

§ 371 Date: Feb. 2, 2010

(30) Foreign Application Priority Data
Feb. 21, 2008 (JP) 2008-040401

(51) Int. Cl. H01M 8/10; H01M 8/04; H01M 2/14

(52) U.S. Cl. 429/482

(57) ABSTRACT

There is provided a fuel cell having a seal structure that has high gas sealability and, further, is capable of supplying gas to a membrane electrode assembly without being path-cut even if there are conventional processing errors (variations) in the gasket. With respect to a gasket 5 provided at the periphery of the membrane electrode assembly, a first seal protrusion 51 is formed around a manifold 6. A notch 31 is formed at an end portion of a gas flow path layer 3. An end portion of the gasket 5 blocks the notch 31 and has at least one second seal protrusion 52 protruding from the surface of the gas flow path layer 3 and having a height of the same level as or less than the first seal protrusion 51. A separator 4 is in contact with the gas flow path layer 3 in a posture where the first seal protrusion 51 and the second seal protrusion 52 are compressed. At least one linear seal structure is formed by the second seal protrusion 52 and the separator 4.

### TECHNICAL FIELD

The present invention relates to solid polymer fuel cells.

### BACKGROUND ART

In a cell of a solid polymer fuel cell, a membrane electrode assembly (MEA) is formed from an ion-permeable electrolyte membrane, and an anode electrode layer and a cathode electrode layer sandwiching the electrolyte membrane, and a unit cell is formed by disposing separators on the outer side thereof. It is noted that there is also a form in which a membrane electrode assembly (MEGA: Membrane Electrode & Gas Diffusion Layer Assembly) is formed by providing gas diffusion layers (GDLs) for promoting gas flow and enhancing collection efficiency on the outer side of the electrode layers, and in which separators are disposed on the outer side of the gas diffusion layers. This separator functions as a gas flow path by defining a cell space and having a concavo-convex form, and is even equipped with a collection function. However, with respect to modern cell structures, there have also been developed cell structures in which a gas flow path layer is provided separately from a flat-type separator. In actual fuel cells, a stack is formed by stacking a predetermined number of stages of such unit cells depending on the power generation capacity.

In the fuel cell mentioned above, hydrogen gas or the like is supplied to the anode electrode as a fuel gas, and oxygen or air is supplied to the cathode electrode as an oxidant gas. At each electrode, gas flows in an in-plane direction through a specific gas flow path layer, and subsequently, the gas that has been diffused at the gas diffusion layer is channeled to an electrode catalyst, where an electrochemical reaction takes place.

However, with respect to the cell structure of a fuel cell, a gasket for providing a gas sealing effect is formed at the periphery of the above-mentioned MEA or MEGA, and the fuel cell disclosed in Patent Document 1 (here, a membrane electrode assembly) may be given as an example. The gasket structure in this membrane electrode assembly will be described with reference to FIGS. 8 and 9. A gasket c comprising double protrusions c1 and c2 is provided at an end portion of an electrolyte membrane a (or a membrane electrode assembly) and gas diffusion layers b1 and b2 sandwiching it. By compressing the double protrusions c1 and c2 while sandwiching the above with separators d1 and d2, sealability against various gasses is enhanced. It is noted that FIG. 8 shows a state before the double protrusions c1 and c2 are compressed with the separators d1 and d2, and FIG. 9 shows a state after compression.

However, the following problems are present in the above-mentioned conventional art. One of them is that, as shown in FIG. 9, because there exists a gap e between the separators d1 and d2 and (the protrusion c1 of) the gasket c, the gas that has flowed through the gas diffusion layers b1 and b2 in the direction of the arrows will not be supplied to the electrolyte membrane a, and will instead flow into the above-mentioned gap e for which pressure loss is relatively low (this is generally referred to as path-cutting in some instances).

As other problems, there are variations in the thickness of the gas diffusion layers b1 and b2 even after compression, and according to the present inventors, it has been identified that a variation of as much as approximately ±35 μm could occur. As problems stemming from such variations in thickness, for cases where the thickness of the gas diffusion layers after compression is too great and for cases where it is too little, there are such respective specific problems as those given below.

First, with respect to cases where the thickness of the gas diffusion layers is too little, it will be readily appreciated that the reaction force acting on the above-mentioned protrusion c1 becomes greater. Due thereto, the loads acting on the electrodes (the electrolyte membrane a, and the gas diffusion layers b1 and b2) become relatively smaller. As a result, the contact resistance between the separators d1 and d2 and the gas diffusion layers b1 and b2 is raised, which becomes a cause for a drop in power generating capacity. Further, due to the fact that the reaction force acting on the protrusion c2 becomes smaller than a desired value, it also becomes a cause for a drop in gas sealability.

On the other hand, when the thickness of the gas diffusion layers is too great, the reaction force acting on the protrusion c1 becomes smaller, as a result of which gas sealability drops, and it becomes more likely for gas to leak between the protrusion c1 and the separators d1 and d2. In addition, due to the fact that the reaction force acting on the protrusion c2 becomes relatively greater, it becomes more likely for the electrodes to short-circuit, making it more probable that the protrusion c2 would break.

Although it would be fair to say that the performance and gas sealability of each cell constituting the fuel cell rest on the above-mentioned variations in the gas diffusion layers, on the other hand, it would be extremely difficult to secure the desired sealability while tolerating the above-mentioned variations. In addition, if a gasket having variations per portion thereof as mentioned above were used, there would be variations in pressure when the fuel cell is integrated as a stack, that is, in the pressure acting on the membrane electrode assembly, which would inhibit uniform power generation across the plane, directly leading to a drop in the power generating capacity of the fuel cell.

Further, with respect to the cell structure shown in FIGS. 8 and 9, there is shown in FIG. 10 a structure further comprising a gas flow path layer that is separated from the above-described separators. In the same figure, it comprises an electrolyte membrane a, gas diffusion layers b1 and b2 sandwiching it, and gas flow path layers f1 and f2 further sandwiching it, there is provided a gasket c that comprises a protrusion c1 in the periphery thereof and a seal protrusion c2 formed around a manifold M, and while sandwiching them with separators d1 and d2, the protrusions c1 and c2 are compressed. It is noted that the this figure shows a cross-section that is cut at the portion where the manifold M, which serves as a gas flow path, is formed

In the cell structure shown in FIG. 10, too, because there exists a gap e between the gas flow path layers f1 and f2 and (the protrusion c1 of) the gasket c, the gas that has flowed through the separator d2 via the manifold M as indicated by the arrows in the figure, will not be supplied to the gas flow path layer f2, and will instead of flow into the above-mentioned gap e for which pressure loss is relatively low.
[Patent Document 1] Japanese Patent Publication (Kohyo) No. 2006-529049 A

### DISCLOSURE OF THE INVENTION

### Problem to be Solved by the Invention

The present invention is made in view of the problems mentioned above, and its object is to provide a fuel cell having a seal structure that, even if there exist conventional processing errors (variations) in the gasket, has superior gas sealability and, further, is capable of supplying gas to the membrane electrode assembly without being path-cut.

### Means for Solving the Problem

In order to achieve the object above, a fuel cell according to the present invention is a fuel cell comprising a membrane electrode assembly that comprises at least an electrolyte membrane and an anode electrode layer and a cathode electrode layer that sandwich it, gas flow path layers that sandwich the membrane electrode assembly, and separators that sandwich the gas flow path layers, and comprising a gasket having a manifold that is formed in the periphery of the membrane electrode assembly and the gas flow path layers and that serves as a gas flow path, wherein, of the gasket, a first seal protrusion is formed around the manifold, a notch is formed at an end portion of the gas flow path layer, and an end portion of the gasket blocks the notch while at the same time having at least one second seal protrusion that protrudes from the surface of the gas flow path layer and that has a height of the same level as or less than the first seal protrusion, and the separator is in contact with the gas flow path layer in a posture where the first seal protrusion and the second seal protrusion are compressed, and at least one linear seal structure is formed by the second seal protrusion and the separator.

A fuel cell of the present invention relates to a fuel cell that is capable of effectively supplying gas to a membrane electrode assembly (which may include gas diffusion layers) by enhancing the tightness of contact between gas flow path layers sandwiching the membrane electrode assembly and a gas sealing gasket formed at then periphery thereof, and, further, that exerts on the membrane electrode assembly a uniform pressure across a plane while even tolerating manufacturing errors in the gas diffusion layers or the like, thus being superior in power generating efficiency and power generating capacity.

As a configuration therefor, a notch is formed at an end portion of the gas flow path layer, and the notch is blocked by placing an end portion of the gasket over this notch, while at the same time at least one seal protrusion (second seal protrusion) that protrudes from the surface of the gas flow path layer is formed at the end portion of the gasket placed over this notch.

A manifold for supplying or discharging gas is formed in the gasket, and a known gas sealing seal protrusion (first seal protrusion) is formed around this manifold.

The above-mentioned second seal protrusion is one that protrudes from the surface of the gas flow path layer and that has a height of the same level as or less than the first seal protrusion. This is because, since the pressure exerted on the second seal protrusion would be directly exerted on the membrane electrode assembly, if, hypothetically, it were taller than the first seal protrusion, excessive pressure would be exerted on the membrane electrode assembly, thereby causing damage to the membrane electrode assembly or becoming a cause for inhibiting uniform power generation across the plane.

As mentioned above, this second seal protrusion may be single or plural. For example, if two second seal protrusions are to be formed, the form would be such that a notch is formed in a frame like manner at the outer periphery of a gas flow path layer that is, for example, rectangular in plan view, and two endless rectangular second seal protrusions are placed on this notch with an interval in-between.

By virtue of the fact that the gas flow path layers are sandwiched by two separators from the anode side and the cathode side and, further, that the pressure from stack formation is exerted, these separators are placed in contact with the gas flow path layers in a posture where the first seal protrusion and the second seal protrusion are compressed, while at least one linear seal structure is formed between the second seal protrusion and the separator.

According to the fuel cell of the present invention mentioned above, the tightness of contact between the gas flow path layers and the gasket is enhanced, and a gap that causes path-cutting would not occur as it would in the above-discussed conventional structure. Further, because at least one protrusion is placed on the notch formed at the end portion of the gas flow path layer, and this, along with the seal protrusion around the manifold, forms a seal structure between itself and the separator, gas sealability is further enhanced.

In addition, another embodiment of a fuel cell according to the present invention is a fuel cell comprising a membrane electrode assembly that comprises at least an electrolyte membrane and an anode electrode layer and a cathode electrode layer that sandwich it, gas flow path layers that sandwich the membrane electrode assembly, and separators that sandwich the gas flow path layers, and comprising a gasket having a manifold that is formed in the periphery of the membrane electrode assembly and the gas flow path layers and that serves as a gas flow path, wherein, of the gasket, a first seal protrusion is formed around the manifold, a notch is formed at an end portion of the gas flow path layer and an end portion of the gasket blocks the notch while at the same time having a plurality of second seal protrusions in a mutually intersecting posture that are at the same level as the surface of the gas flow path layer or protrude from the surface, and the separator is in contact with the gas flow path layer in a posture where the first seal protrusion is compressed, and a planar seal structure is formed by the mutually intersecting second seal protrusions and the separator.

In this embodiment, instead of forming the second seal protrusions in a linear fashion, the second seal protrusions are made to mutually intersect in, for example, a grid-like fashion, and these grid-like second seal protrusions are placed on the notch at the end portion of the gas flow path layer.

By virtue of the fact that the second seal protrusions mutually intersect, even if, hypothetically, the heights of the second seal protrusions and the gas flow path layers were of the same level (thus, the pressure from stack formation not being exerted on the second seal protrusions), the pressure loss with respect to gas flow between them and the separator becomes extremely high, and gas leakage from the gas flow path layers is effectively suppressed.

The above-mentioned fuel cell is superior in terms of gas sealability, and is superior in terms of power generating efficiency and power generating capacity. Thus, production thereof has been expanding recently, and it is suitable for hybrid vehicles, electric vehicles and the like for which for-vehicle fuel cells with high power generating capacity are an imperative issue.

### Effects of the Invention

As can be understood from the description above, according to a fuel cell of the present invention, it is possible to obtain a fuel cell in which the tightness of contact between the gas flow path layers and the gasket is enhanced and in which gas sealability is enhanced. Further, even in cases where there are manufacturing errors in the gas diffusion layers, it is possible to tolerate them and exert on the membrane electrode assembly pressure from stack formation that is uniform across a plane, and it is possible to obtain a fuel cell with superior power generating capacity.

### BRIEF DESCRIPTION OF THE DRAWINGS

FIG. 1 is a plan view of a cell structure in which a membrane electrode assembly is sandwiched by gas flow path layers.

FIG. 2 is a fragmentary view taken along arrows in FIG. 1.

FIG. 3 is an enlarged view of portion III in FIG. 2.

FIG. 4 is a sectional view showing a state where a separator on the cathode side is attached to the sectional view in FIG. 2.

FIG. 5 is a view showing another embodiment of a gasket, and is a plan view in which a connection portion between an end portion of a membrane electrode assembly and the gasket is enlarged.

FIG. 6 is a fragmentary view taken along arrows VI-VI in FIG. 5.

FIG. 7 is a sectional view showing a state where a separator on the cathode side is attached to the sectional view in FIG. 6.

FIG. 8 is an illustrative sectional view before a seal structure by means of a conventional gasket at an end portion of a membrane electrode assembly is formed.

FIG. 9 is a sectional view illustrating a seal structure by means of a conventional gasket at an end portion of a membrane electrode assembly.

FIG. 10 is a sectional view of another embodiment of a seal structure by means of a conventional gasket at an end portion of a membrane electrode assembly.

### DESCRIPTION OF SYMBOLS

1 . . . electrolyte membrane (MEA), 2 . . . gas diffusion layer (GDL), 3 . . . gas flow path layer, 31 . . . notch, 32 . . . reinforcement member, 4 . . . separator, 41 . . . instant cell separator, 42 . . . gas distribution layer, 43 . . . adjacent cell separator, 5, 5A . . . gasket, 51 . . . seal protrusion (first seal protrusion), 52 . . . linear seal protrusion (second seal protrusion), 53 . . . planar seal protrusion (second seal protrusion), 54 . . . groove, 6 . . . manifold

### BEST MODE FOR CARRYING OUT THE INVENTION

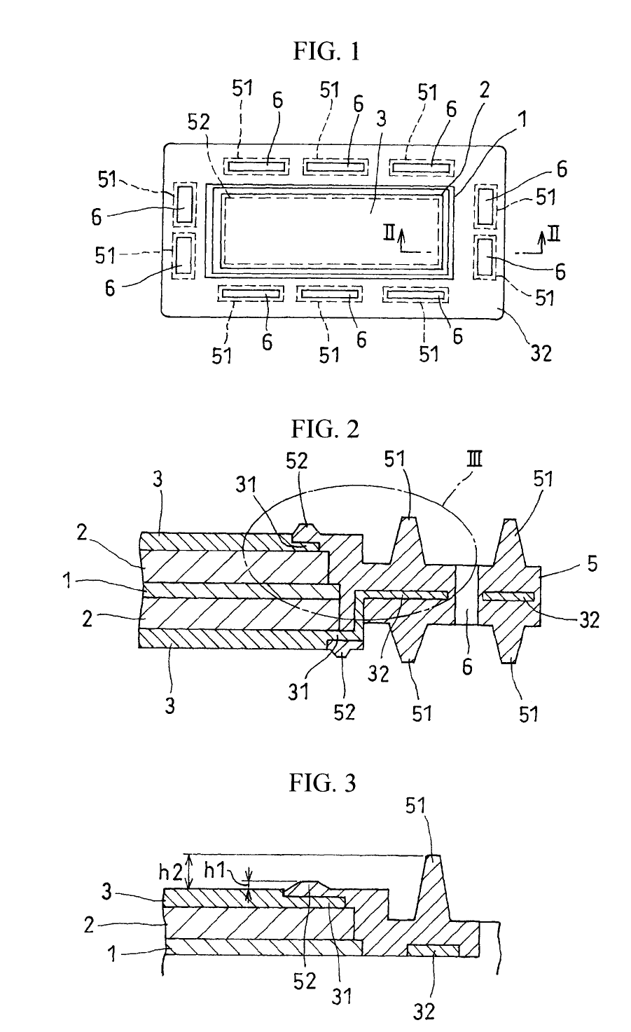

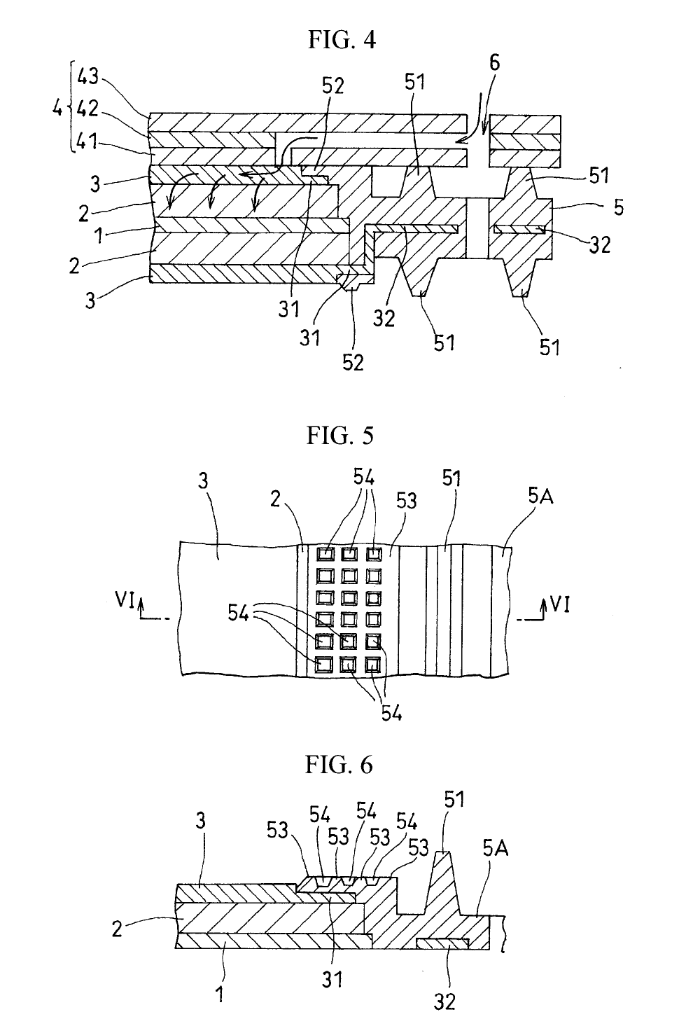

Embodiments of the present invention are described below with reference to the drawings. FIG. 1 is a plan view of a cell structure in which a membrane electrode assembly is sandwiched by gas flow path layers. FIG. 2 is a fragmentary view taken along arrows II-II in FIG. 1. FIG. 3 is an enlarged view of portion III in FIG. 2. FIG. 4 is a sectional view showing a state where a separator on the cathode side is attached to the sectional view in FIG. 2. It is noted that while the linear seal protrusions (second seal protrusions) shown in the drawings are lower in height than the seal protrusions (first seal protrusions) around the manifold, the two may naturally be of the same height as well.

The cell structure shown in FIGS. 1 and 2 comprises a membrane electrode assembly (MEA), which formed from an electrolyte membrane 1 (MEA) that is an ion exchange membrane and gas diffusion layers 2, 2 (GDL) on the anode side and the cathode side that sandwich it, and gas flow path layers 3, 3, which are electrically conductive porous bodies that sandwich this membrane electrode assembly, and a gasket 5 made of a resin such as rubber or the like, for example, is integrally formed at the periphery thereof. It is noted that, for purposes of aiding the intelligibility of FIG. 1, the gasket 5 shown in FIG. 2 is omitted in FIG. 1.

The electrolyte membrane 1 comprises a polymeric material such as a fluorinated membrane, an HC membrane, or the like. The gas diffusion layer 2 is a porous material in which a catalyst comprising platinum or an alloy thereof is supported by carbon or the like, and is formed from carbon paper or carbon cloth. In addition, the gasket 5 may be formed by insert molding wherein a membrane electrode assembly (MEGA) is housed within a mold, and a resin of choice is injected into the mold.

In the example shown in the drawings, the gas flow path layer 3 comprises porous lath metal, and serves as a reinforcement member 32 of the gasket 5 by having, for example, an end portion of the lath metal on the anode side bend towards the cathode side and bend further to extend towards the side of a manifold 6. By virtue of the fact that the gas flow path layer 3 is formed of relatively hard lath metal, dual use as the above-mentioned reinforcement member is made possible.

As shown in the plan view in FIG. 1, as many holes (manifolds 6) for supplying hydrogen gas and oxygen gas (or air), and as many holes (manifolds 6) for discharging the gas after reaction as the number of units respectively corresponding thereto are bored in the reinforcement member 32 of the gasket. In an actual fuel cell, unit cells are stacked in a quantity that matches the power generating capacity, and the gas supplying or discharging manifolds 6 are formed as the corresponding holes are connected in the stacking direction.

As shown in FIG. 2, notches 31 are formed at end portions of the gas flow path layers 3. Linear seal protrusions 52 formed at end portions of the gasket 5 are placed on these notches 31, and these protrusions 52 are in complete and tight contact with the notches 31 to block them. On the other hand, separate seal protrusions 51 are formed at portions of the gasket 5 surrounding the manifolds 6. Referring back to FIG. 1, this seal protrusion 52 is formed in an endless form with a rectangular outline along the end sides of the membrane electrode assembly that is rectangular in plan view, and the seal protrusion 51 is formed around each manifold 6 so as to surround it.

FIG. 3 is an enlarged view of portion III in FIG. 2. As shown in this figure, the linear seal protrusion 52 placed on the notch 31 protrudes from the upper surface of the gas flow path layer 3 by h1, and is so formed as to be lower than the seal protrusion 51 that protrudes by h2 which is higher than h1. By virtue of the fact that the seal protrusion 51 is so formed as to be relatively higher, the seal around the manifold 6 can be better enhanced and, further, no excessive pressure is exerted on the membrane electrode assembly below the linear seal protrusion 52. It is noted that, from the relationship between gas sealability and the pressure exerted on the membrane electrode assembly, it is preferable that the setting range for this h1 be on the order of 0≦h1≦50 μm. Here, if the linear seal protrusion 52 is single, it is preferable that h1 be set to a value greater than 0. For a structure of two or more protrusions, due to the fact that the pressure loss with respect to gas flow becomes higher, it also becomes possible to set h1 to 0, that is, to set it to the same level as the upper surface of the gas flow path layer 3.

FIG. 4 shows a state where the gas flow path layers 3, 3 of the structure shown in FIG. 2 are sandwiched by separators 4, 4. Here, the separator 4 shown in the drawing has a structure wherein a gas distribution layer 42, which is for distributing oxygen gas to an instant cell separator 41 and for distributing hydrogen gas to an adjacent cell separator 43, lies between the flat-type instant cell separator 41 and adjacent cell separator 43. It is noted that this separator 4 is a separator made of metal or carbon.

For example, oxygen gas supplied via the manifold 6 for supplying oxygen gas flows in the direction of the arrows shown in the figure, and is diffused and supplied to the membrane electrode assembly after being supplied to the gas flow path layer 3.

As is apparent from FIG. 4, the linear seal protrusion 52 on the notch 31 formed at the end portion of the gas flow path layer 3 is in tight contact with the notch 31. As a result of the linear seal protrusion 52 being pressed upon and compressed by the separator 4 in this posture, no gap for gas to path-cut is formed, and all of the supplied gas is effectively supplied to the membrane electrode assembly via the gas flow path layer 3.

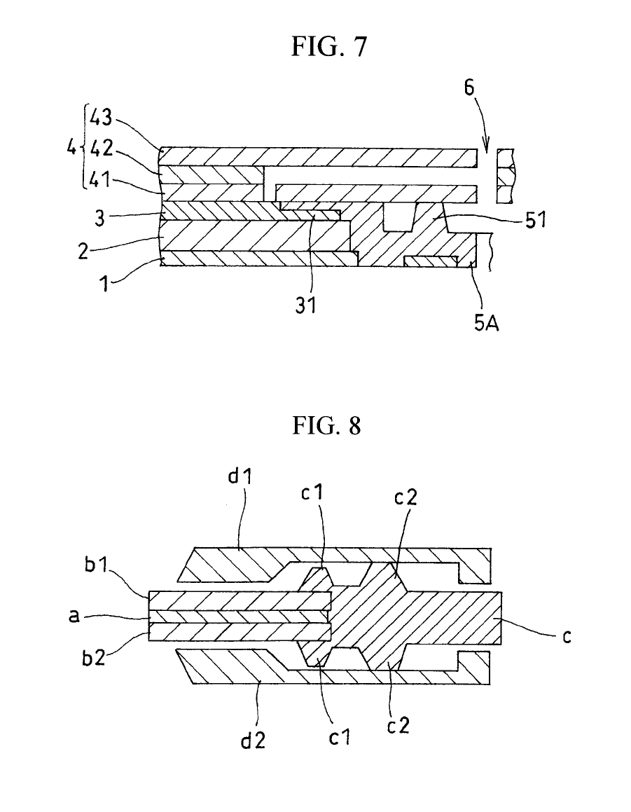

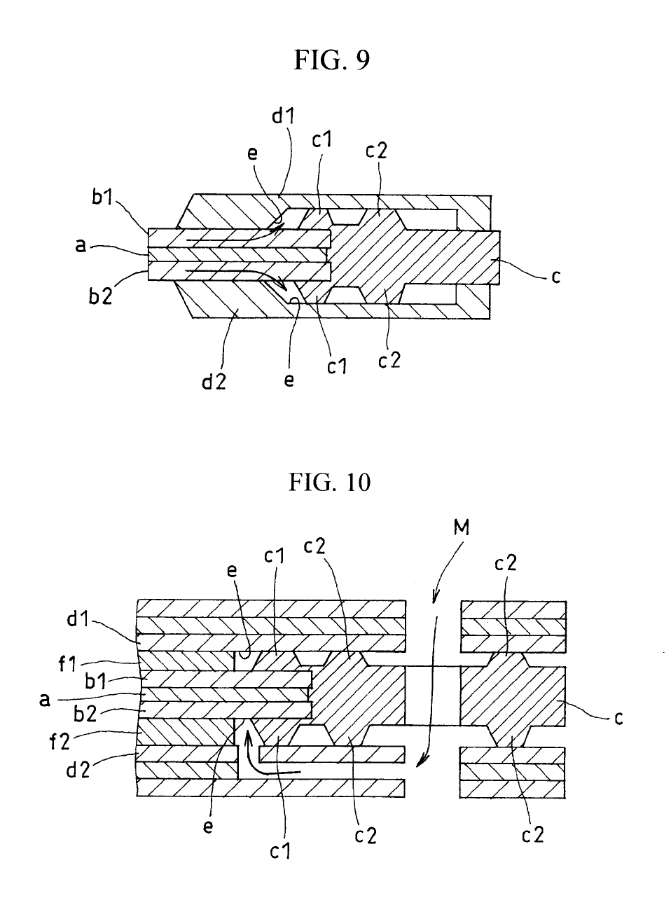

FIG. 5 is a plan view showing another embodiment of a seal protrusion placed on the notch 31, and FIG. 6 is a fragmentary view taken along arrows VI-VI thereof. Further, FIG. 7 is a diagram showing a state where a separator on the cathode side is attached to the configuration in FIG. 6.

The seal protrusion 53 shown in the drawings has a grid-like configuration (grooves 54 are formed) wherein linear seal protrusions alternately intersect, and this is formed in a planar arrangement similar to that of the linear seal protrusion 52 in FIG. 1. In contrast to the seal protrusions 52 shown in FIG. 2 which are linear, this seal protrusion 53 is one which contacts the separator 4 with a plurality of flat top faces of the grid-like seal protrusion 53. In other words, since it contacts in a planar, as opposed to linear, fashion, it forms a planar seal protrusion 53.

It is noted that, although there is shown in FIG. 6 a form wherein this planar seal protrusion 53 protrudes slightly from the upper surface of the gas flow path layer 3, the protrusion 53 and the gas flow path layer 3 may be at the same level. This is because since the planar seal protrusion 53 has a grid-like configuration, even under conditions where this is not subjected to pressure at the plane of contact with the separator 4, the pressure loss with respect to gas flow becomes high at this grid-like contact structure, and gas leakage via the contact plane between the separator 4 and the planar seal protrusion 53 is thus suppressed.

A fuel cell is manufactured by forming a stack by stacking a number of unit cells having the above-mentioned seal structure in accordance with the power generating capacity, further providing terminal plates, insulators, and end plates at the perimeter of the stack, and integrating them by applying the desired pressure across these end plates.

By having the above-mentioned seal structure, this fuel cell becomes a fuel cell that is superior in power generating efficiency and power generating capacity. This fuel cell is applicable in a variety of uses such as for mobile objects such as aircrafts, ships, mobile robots and the like, and further for stationary uses, such as in houses and the like. However, it is particularly suitable for application in hybrid vehicles, electric vehicles and the like for which for-vehicle fuel cells with high power generating capacity are an imperative issue.

Embodiments of the present invention have been described in detail above using drawings. However, specific configurations are by no means limited to such embodiments. Even if design modifications and the like were to be made within a scope that does not depart from the spirit of the present invention, they are to be included in the present invention.

1. A fuel cell comprising a membrane electrode assembly that comprises at least an electrolyte membrane and an anode electrode layer and a cathode electrode layer that sandwich it, gas flow path layers that sandwich the membrane electrode assembly, and separators that sandwich the gas flow path layers, and comprising a gasket having a manifold that is formed in the periphery of the membrane electrode assembly and the gas flow path layers and that serves as a gas flow path, wherein,
of the gasket, a first seal protrusion is formed around the manifold,
a notch is formed at an end portion of the gas flow path layer, and an end portion of the gasket blocks the notch while at the same time having at least one second seal protrusion that protrudes from the surface of the gas flow path layer and that has a height of the same level as or less than the first seal protrusion, and
the separator is in contact with the gas flow path layer in a posture where the first seal protrusion and the second seal protrusion are compressed, and at least one linear seal structure is formed by the second seal protrusion and the separator.

2. A fuel cell comprising a membrane electrode assembly that comprises at least an electrolyte membrane and an anode electrode layer and a cathode electrode layer that sandwich it, gas flow path layers that sandwich the membrane electrode assembly, and separators that sandwich the gas flow path layers, and comprising a gasket having a manifold that is formed in the periphery of the membrane electrode assembly and the gas flow path layers and that serves as a gas flow path, wherein,
of the gasket, a first seal protrusion is formed around the manifold,
a notch is formed at an end portion of the gas flow path layer and an end portion of the gasket blocks the notch while at the same time having a plurality of second seal protrusions in a mutually intersecting posture that are at the same level as the surface of the gas flow path layer or protrude from the surface, and
the separator is in contact with the gas flow path layer in a posture where the first seal protrusion is compressed, and a planar seal structure is formed by the mutually intersecting second seal protrusions and the separator.
